(19) United States
(12) Patent Application Publication
(10) Pub. No.: US 2015/0154887 A1
(43) Pub. Date: Jun. 4, 2015

(54) DEVICES, SYSTEMS AND METHODS OF ASSESSING THE RISK OF OBESITY LATER IN LIFE OF AN INFANT OR A YOUNG CHILD

(71) Applicant: NESTEC S.A., Vevey (CH)

(72) Inventor: Evelyn Spivey-Krobath, Savigny (CH)

(21) Appl. No.: 14/555,603

(22) Filed: Nov. 27, 2014

Related U.S. Application Data
(60) Provisional application No. 61/910,140, filed on Nov. 29, 2013.

(51) Int. Cl. G09B 23/28; G09B 5/00

(52) U.S. Cl. CPC G09B 23/28; G09B 5/00

(57) ABSTRACT

A device, a system and a method to assess the risk of obesity later in life of an infant or young child. The device, the system and the method enable a user such as a parent to evaluate the weight gain of the infant or young child and receive recommendations to ensure a healthy growth for the infant or young child. A device including a processor can execute an application that requests information related to the risk of obesity later in life for an infant or young child, evaluates the risk of obesity later in life for an infant or young child, and updates the information and the result of the evaluation as additional information is obtained. A message or a warning such as an alert on the risk for the infant or the young child to become obese can be provided by the application based on the information and/or the evaluation of the information.

### PRIORITY CLAIM

This application claims priority to U.S. Provisional Application No. 61/910,140, filed on Nov. 29, 2013, the entire contents of which are being incorporated herein by reference.

### BACKGROUND

The present disclosure generally relates to devices, systems and methods for assessing the risk of obesity later in life of an infant or a young child. More specifically, the present disclosure relates to devices, systems and methods that enable a user, such as a parent, to evaluate the weight gain of the infant or the young child and receive recommendations from a health care professional to ensure a healthy growth for the infant or the young child.

The prevalence of obesity and overweight in adults, children and adolescents has increased rapidly over the past 30 years in the United States and globally and continues to rise. Overweight and obesity are classically defined based on the percentage of body fat or, more recently, the body mass index (“BMI”). The BMI is defined as the value resulting from division of a numerator that is the weight in kilograms by a denominator that is the height in meters, squared. Alternatively, the BMI can be calculated from the weight in pounds as the numerator and the height in inches, squared, as the denominator, with the resultant quotient multiplied by 703.

As overweight and obesity become more prevalent in all age groups, inevitably the number of women giving birth who are also overweight or obese will also increase. Overweight and obese women who become pregnant have a greater risk of developing gestational diabetes. Maternal hyperglycemia may lead to infants with increased body size and fat mass, and such infants are themselves prone to develop obesity and diabetes later in childhood or in adult life. Moreover, recent research has suggested that obese women who have normal glucose tolerance give birth to infants with a higher fat mass than those born to women who are not obese.

Scientific evidence continues to suggest that infants born to overweight and obese mothers have a greater risk of becoming overweight or obese later in life than infants born to mothers who are not overweight or obese. Childhood overweight and obesity currently affects 18 million children under age 5 worldwide. Almost 30% of U.S. children and adolescents and between 10 and 30% of European children are overweight or obese.

Some existing devices on the market allow a parent to follow the growth of the baby, but the growth pattern is not evaluated. For example, the growth pattern is not evaluated to determine a risk for later obesity development. Furthermore, known tools for estimating the risk of the baby to become obese do not consider all risk factors for obesity recently established in research and which can be influenced through proper nutritional solutions.

### SUMMARY

The present disclosure provides devices, systems and methods for assessing the risk of obesity later in life for an infant or a young child. The present disclosure provides applications for use with a mobile device, such as a tablet or a smartphone, for parents to evaluate the risk of obesity of their baby. The parents will be able to use the mobile device to track the growth pattern of their babies, and based on recently defined risk factors for obesity the parents can be alerted to a risk for the infant or the young child to become obese and that a health care professional should be consulted for advice on possible nutritional solutions.

Accordingly, in an embodiment, the present disclosure provides a method that includes accepting user input into an application executed by a device comprising a processor, the user input comprising the weights and lengths (so that the application will define the weight-for-length values that illustrate the weight gain) of an infant or young child at a plurality of ages after birth. It may also comprise other input such as the birth date of an infant or young child, the birth weight of an infant or young child, the birth length of an infant or young child, but also the BMI or the weight and length (to define the BMI) of the mother before pregnancy. The device automatically performs an analysis of the risk of obesity later in life for the infant or the young child based at least partially on the weights and lengths of the infant or the young child.

In an embodiment, the method includes providing a message or a warning on the device based at least partially on the analysis, and the message is selected from the group consisting of an alert on the risk for the infant or the young child to become obese, a recommendation suggesting a visit to a healthcare professional, educational information regarding the risk of obesity later in life of the infant or the young child, and combinations thereof.

In an embodiment, the analysis is at least partially based on whether the infant is breastfed.

In an embodiment, the analysis is at least partially based on a criterion selected from the group consisting of a threshold pre-pregnancy body mass index (BMI) of the mother of the infant or the young child, a threshold weight of the infant at birth, and combinations thereof.

In an embodiment, the results of the analysis are provided by the application in a user interface of the device.

In an embodiment, the method includes generating a weight gain curve (or growth curve) based at least partially on the weights and lengths, (i.e. based on the weight-for-length values calculated by the application), at the plurality of ages.

In an embodiment, the method includes updating the application based on a criterion for the risk of obesity later in life that was identified after the device obtained the application.

In another embodiment, a device is provided. The device comprises a processor that executes an application that directs the device to provide data fields for entry of information related to a risk of obesity later in life of an infant or a young child, the information comprising weights and lengths (to determine the weight-for-length values) of the infant or the young child at a plurality of ages after birth, and the application uses the processor to evaluate the risk of obesity later in life of the infant or the young child based at least partially on the information. Alternatively it could be also imagined in some embodiments that the information can also be directly the weight-for-length values entered by the user.

In an embodiment, the device is selected from the group consisting of a tablet, a smartphone, a desktop computer, a laptop computer, and a personal digital assistant.

In an embodiment, the device accepts the weights and the lengths of the infant or the young child sequentially.

In an embodiment, a system is provided. The system comprises a database connected to a remotely located device comprising a processor executing an application that evaluates a risk of obesity later in life of an infant or a young child. The database automatically updates the application on the device with a factor (e.g. a new factor) for the risk of obesity later in life of an infant or a young child.

In an embodiment, the database stores at least a portion of information entered into the application on the device relating to the risk of obesity later in life of a specific infant or a young child.

In another embodiment, a method is provided. The method comprises accepting user input into an application executed by a device comprising a processor, the user input comprising information related to a first factor associated with a risk of obesity later in life of an infant or a young child, the user input accepted at a first time; accepting additional user input into the application at a second time subsequent to the first time, the additional user input comprising information related to a second factor associated with the risk of obesity later in life for the infant or the young child; and performing an analysis of the risk of obesity later in life of the infant or the young child, the analysis based at least partially on the information related to the first and second factors.

In an embodiment, the method includes performing a preliminary analysis of the risk of obesity later in life of the infant or the young child, the preliminary analysis based at least partially on the information related to the first factor and performed before the additional user input.

In an embodiment, the first factor is selected from the group consisting of whether the infant is breastfed, the pre-pregnancy body mass index (BMI) of the mother of the infant or young child, the weight of the infant at birth, and combinations thereof.

In an embodiment, the second factor includes the weight-for-length values (determined by the weights and lengths values entered by the user) of the infant or the young child at a plurality of ages after birth as percentiles relative to other infants or young children of the same age and gender.

In another embodiment, a method is provided. The method comprises accepting user input into an application executed by a device comprising a processor, the user input comprising information related to a risk of obesity later in life of an infant or young child. The device automatically provides a message or a warning based at least partially on the information related to the risk of obesity later in life of the infant or the young child and that may be either an educational information; an alert on the risk for the infant or the young child to become obese, or a recommendation suggesting a visit to a healthcare professional who may provide a nutritional suggestion, i.e. a recommendation of a nutritional composition or a set of nutritional compositions for the infant or the young child.

An advantage of the present disclosure is to assess and/or reduce the risk of obesity later in life of an infant or a young child.

Another advantage of the present disclosure is to raise awareness of a parent, such as a mother, about the risk of obesity later in life for her child.

Still another advantage of the present disclosure is to encourage prevention of infant obesity.

Yet another advantage of the present disclosure is to evaluate the risk of obesity by considering various factors including, for example, one or more of breastfeeding or a lack thereof, BMI of the mother, birth weight of the infant, or rapid weight gain (i.e. a rapid weight-for-length increase) of the infant or of the young child (e.g. over the first two years of life such as over the first months of life of the infant such as the first six months of life).

An additional advantage of the present disclosure is to update the criteria by which the risk of obesity later in life of an infant or a young child is analyzed such that the most up-to-date information is employed in the analysis.

Another advantage of the present disclosure is an application executed by a mobile device that evaluates the risk of obesity later in life of an infant or a young child.

Still another advantage of the present disclosure is to monitor the weight gain at an early stage of life, for example the first six months.

Yet another advantage of the present disclosure is to identify any weight gain of the infant or young child that crosses at least one major percentile.

Still another advantage of the present disclosure is to define the obesity risk level for later in life of an infant or a young child.

Yet another advantage of the present disclosure is to identify appropriate action(s) for a parent if a risk or a high risk of obesity later in life of an infant or a young child is identified.

An additional advantage of the present disclosure is an easily navigable application to evaluate the risk of obesity later in life of an infant or a young child.

Another advantage of the present disclosure is to compile information that can help a pediatrician treating an infant or a young child, for example by providing recommendations on a nutritional suggestion with adequate product solutions.

Still another advantage of the present disclosure is to enhance retention of educational information regarding the risk of obesity later in life of an infant or a young child.

Yet another advantage of the present disclosure is providing graphics to assist understanding of the risk of obesity later in life of an infant or a young child.

An additional advantage of the present disclosure is to evaluate the risk of obesity later in life of an infant or a young child using an application that is helpful in both one use only and in continued usage.

Another advantage of the present disclosure is an online application to evaluate the risk of obesity later in life of an infant or a young child.

Still another advantage of the present disclosure is an application accessible over the internet that evaluates the risk of obesity later in life of an infant or a young child.

Yet another advantage of the present disclosure is to use a smartphone or a tablet to monitor factors related to the risk of obesity later in life of an infant or a young child and to evaluate the risk of obesity later in life of an infant or a young child.

An additional advantage of the present disclosure is to monitor and evaluate the weight gain of an infant or young child for at least the first six months after birth.

Additional features and advantages are described in, and will be apparent from, the following Detailed Description and the Figures.

### BRIEF DESCRIPTION OF DRAWINGS

FIG. 1 illustrates an embodiment of an introductory screen of a user interface of a device executing an application provided by the present disclosure.

FIG. 2 illustrates an embodiment of a profile creation screen of a user interface of a device executing an application provided by the present disclosure.

FIG. 3 illustrates an embodiment of a profile summary screen of a user interface of a device executing an application provided by the present disclosure.

FIG. 4 illustrates an embodiment of an evaluation summary screen of a user interface of a device executing an application provided by the present disclosure.

FIG. 5 illustrates an embodiment of a growth curve screen of a user interface of a device executing an application provided by the present disclosure.

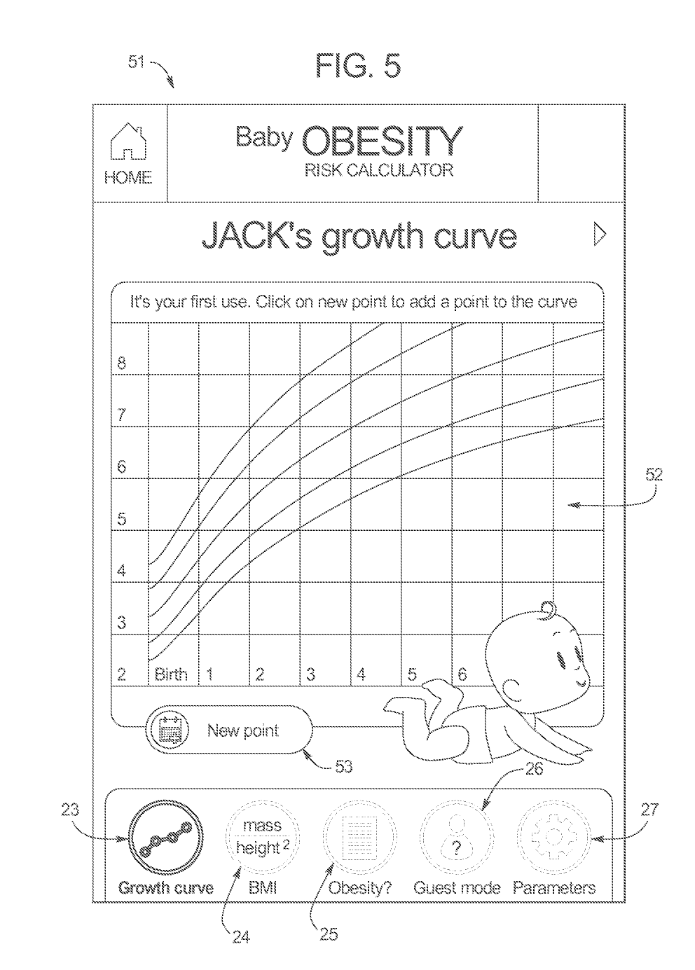

FIG. 6 illustrates an embodiment of a BMI information screen of a user interface of a device executing an application provided by the present disclosure.

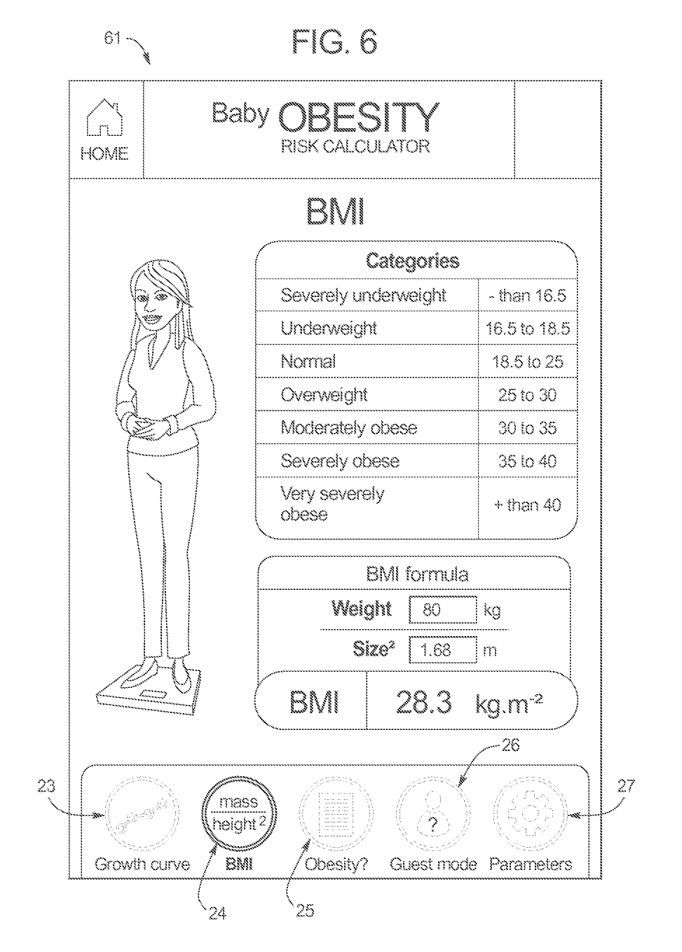

FIG. 7 illustrates an embodiment of an obesity information screen of a user interface of a device executing an application provided by the present disclosure.

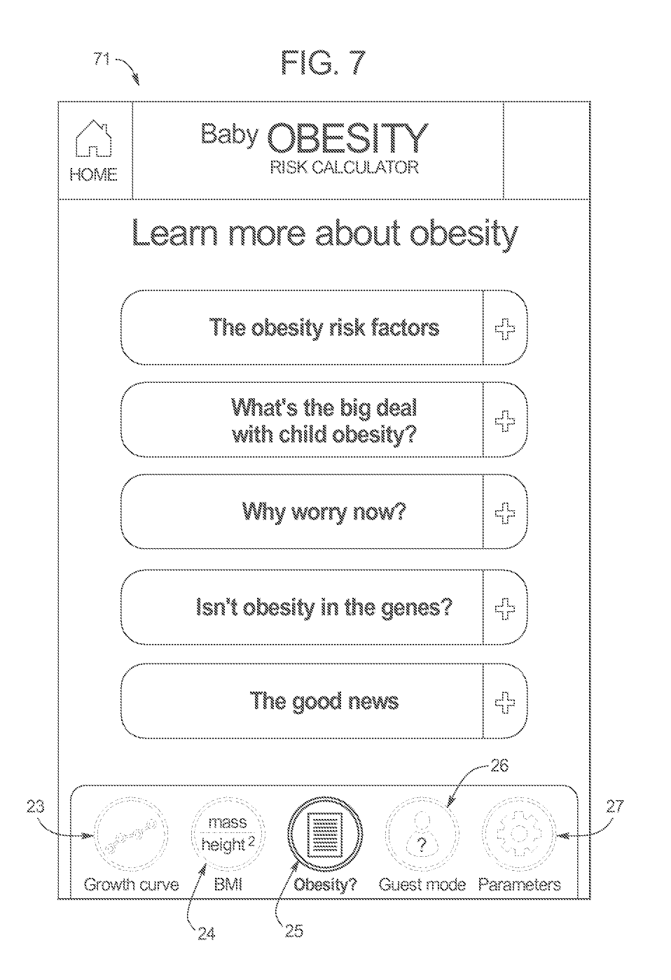

FIG. 8 illustrates an embodiment of a guest mode screen of a user interface of a device executing an application provided by the present disclosure.

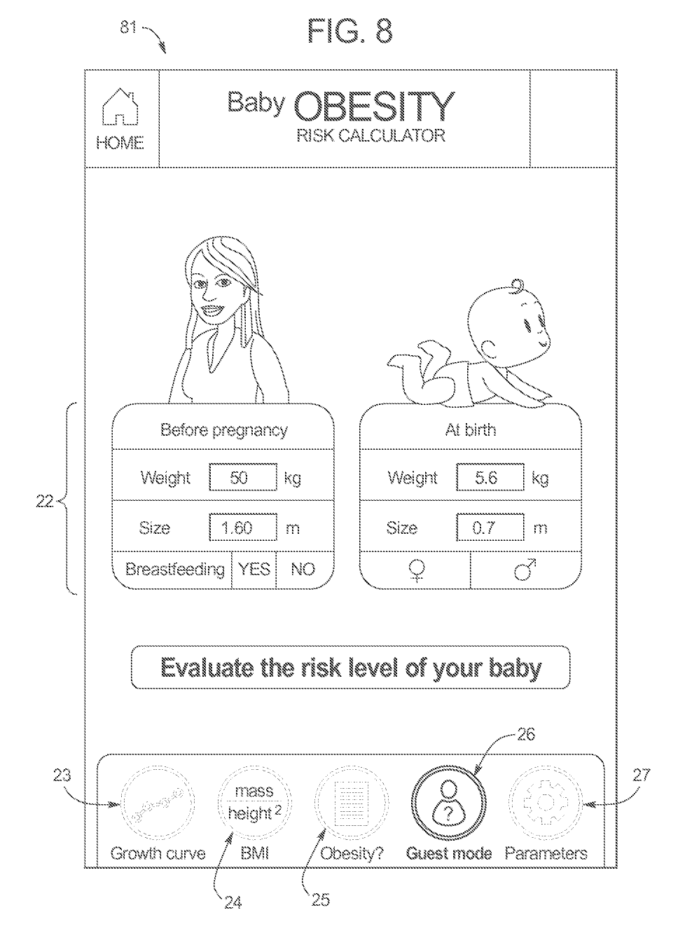

FIG. 9 illustrates an embodiment of a parameters screen of a user interface of a device executing an application provided by the present disclosure.

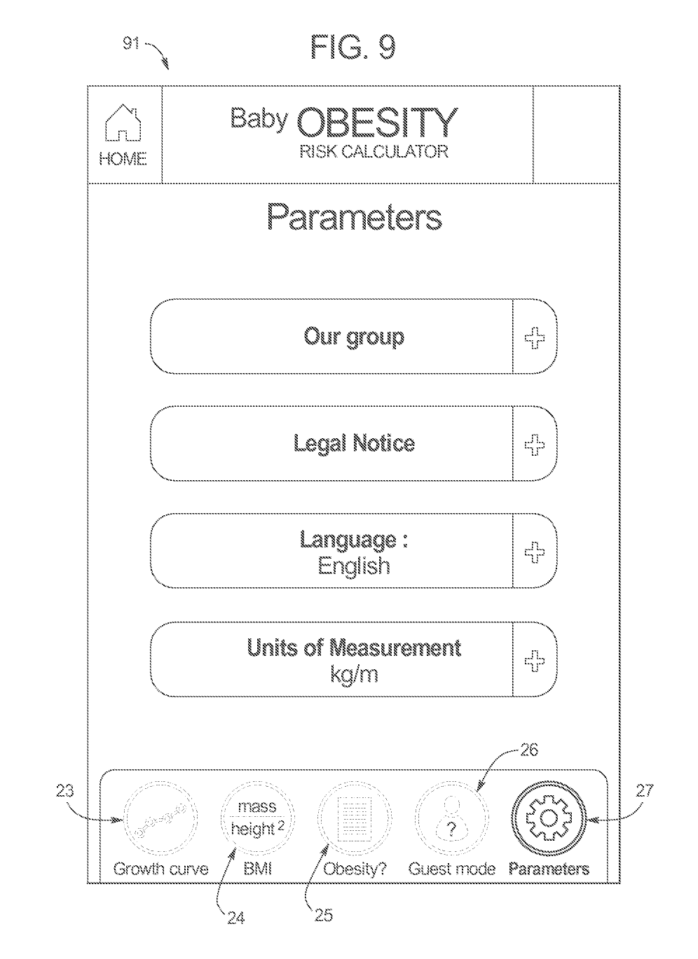

FIG. 10 illustrates an embodiment of a method provided by the present disclosure.

### DETAILED DESCRIPTION

All percentages and ratios are by weight unless otherwise specified.

The term “database” means the hardware (e.g., a computer) and/or the software (e.g., a computer application) that receives, stores, processes and delivers content that can be accessed, for example, through the internet using a website hosted by the database and/or a web server associated with the database.

The term “automatically” means without user input being necessary. An “automatically” performed operation can comprise one or more actions by the corresponding device, but each of the actions is performed without a requirement of user input.

The term “sequentially” means that information is input in a successive manner such that a first portion of the information is input at a first time, a second portion of the information is input at a second time subsequent to the first time, and so on. The time between sequential inputs may be, for example, one or several minutes, hours, days, weeks, months, or the like.

The devices, systems and methods according to the present invention can be applied to infants and/or young children. Preferably they are used for infants. The term “infant” means a child under the age of 12 months. The infants are preferably term infants. The expression “young child” means a child aged between one and three years, also called toddler.

The expression “nutritional composition” means a composition which nourishes a subject. This nutritional composition is usually to be taken orally or intravenously, and it usually includes a lipid or fat source and a protein source. Some examples are infant formula, growing-up milks, supplements . . . . They can be in powder or liquid forms.

The expression “infant formula” means a foodstuff intended for particular nutritional use by infants during the first months of life and satisfying by itself the nutritional requirements of this category of person (Article 2(c) of the European Commission Directive 91/321/EEC 2006/141/EC of 22 Dec. 2006 on infant formulae and follow-on formulae). Generally a starter formula is for infants from birth as breast-milk substitute, and a follow-up or follow-on formula is given from the 6^{th} month onwards. “Growing-up milks” (or GUMs) are given from one year onwards. The expression “growing-up milk” means a milk-based beverage adapted for the specific nutritional needs of young children.

The term “later in life” refers to effects measured in the child after the age of 1 year after birth, such as after the age of 2 years, preferably after the age of 4 years, more preferably after the age of 5 years, even more preferably after the age of 7 years after birth and as a comparison to average observations for subjects of the same age.

“Overweight” is defined for a human as a BMI between 25 and 30. “Obese” is defined for a human as a BMI greater than 30.

“Risk factors” or “factors related to the risk of obesity later in life of an infant or a young child” are parameters and/or elements that allow evaluating the risk of obesity of said infant or young child. Some factors associated to a risk for an infant or young child to develop obesity later in life include—but are not limited to—the fact that an infant is not breastfed, the fact that an infant is born to a mother having a high BMI (i.e. an overweight or obese mother), the fact that an infant is born with a high birth weight (4 kg for example), the fact that an infant or a young child has a rapid weight gain (that is generally calculated over the first two years of life and especially over the first months of life of the infant such as the first six months of life). The more risk factors the infant or young child has, the higher will be the risk for said infant or young child to develop obesity later in life.

The expression “weight gain” corresponds to the “weight-for-length gain” or “weight-for-length increase” over a certain period. It may be illustrated by a weight-for-length curve, also called growth curve or weight gain curve. These expressions can be used interchangeably.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a measuring device” or “a method” includes a plurality of such “measuring devices” or “methods.” Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of” and “consisting of” the disclosed components. Where used herein, the term “examples,” particularly when followed by a listing of terms, is merely exemplary and illustrative, and should not be deemed to be exclusive or comprehensive.

It is noted that the various aspects, features, examples and embodiments of the devices, systems and methods described in the present disclosure may be compatible and/or combined together, unless otherwise specified.

The present disclosure is generally directed to devices, systems and methods for assessing the risk of obesity later in life of an infant or a young child. For example, an application executed by a device comprising a processor can evaluate the risk of obesity of an infant or a young child based on information entered into the application and criteria provided by the application. In an embodiment, the application can provide educational information regarding obesity risk factors.

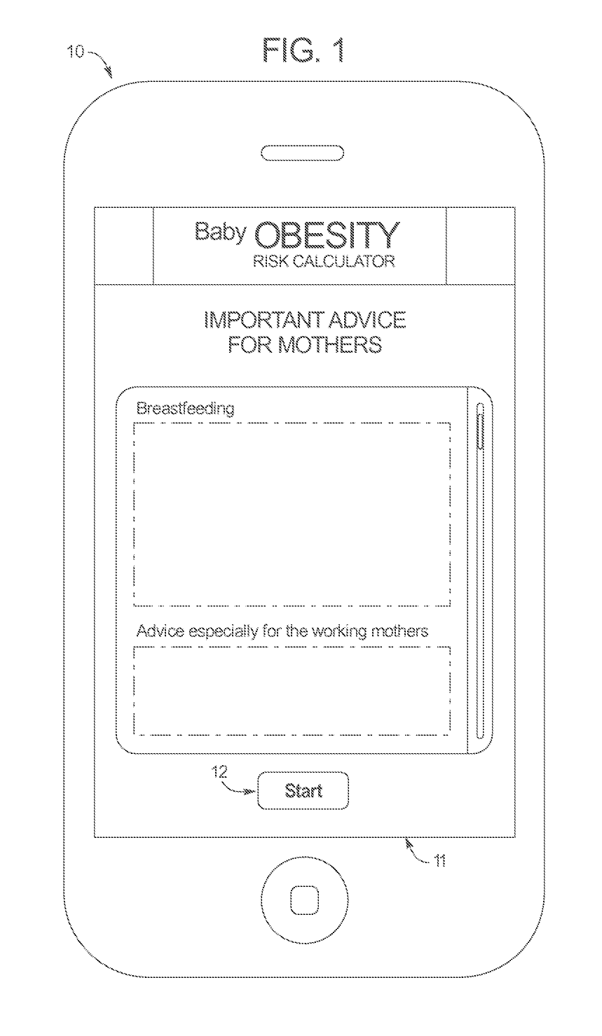

For example, as generally shown in FIG. 1, the application can be executed by a device 10 of a user, preferably a parent such as a mother of an infant or young child. The device 10 can be at least one of a mobile telephone, such as a smartphone; a laptop computer; a desktop personal computer; a tablet; or a personal digital assistant. The application can be executed and/or stored by the device 10, which is a stationary and/or mobile communications device, for example a device that comprises a processor and is at least one of a mobile telephone, such as a smartphone; a laptop computer; a desktop personal computer; a tablet; or a personal digital assistant. The application can be obtained by the device 10 using wired and/or wireless networks, for example the internet, telephone lines, WiFi/WLAN, 3G networks, or the like.

The device 10 can be a general-purpose computer selectively reconfigured by the application. The device 10 can store the application in a non-transitory computer readable storage medium that is any computer-readable media except for a transitory, propagating signal. Non-limiting examples of computer-readable media that can store the application include any type of disk including optical disks, CD-ROMs, and magnetic-optical disks; read-only memories (ROMs); random access memories (RAMs); EPROMs; EEPROMs; magnetic or optical cards; application specific integrated circuits (ASICs); and any type of media suitable for storing electronic instructions.

The application can be obtained and/or can be accessed by selection of a corresponding icon using the device 10. The icon can visually indicate the identity of the application, such as by depicting an infant on a scale. In an embodiment, the application can be obtained from an application store for the corresponding type of device 10 or operating system of the device 10. In an embodiment, the application can be accessed using a web browser and the internet.

The device 10 executing the application can provide a user interface comprising an introductory screen 11. The introductory screen 11 can comprise educational information regarding factors for the risk of obesity later in life of an infant or young child. In an embodiment, the educational information can comprise information regarding breastfeeding, for example that frequent breastfeeding and a well balanced diet for the mother are encouraged and partial breastfeeding is better than complete bottle feeding. The introductory screen 11 can comprise a “start” button 12 that can enable the user to initiate evaluation of the risk of obesity later in life for the infant or young child.

Subsequent figures do not show the device 10, but it is to be understood that all of the screens disclosed herein are displayed on the device 10. Furthermore, the screens may be displayed by the application in any order, and the present disclosure is not limited to the order of screens depicted in the figures and discussed in the text. Moreover, the screens displayed by the application may include additional screens not disclosed herein and may lack one or more of the screens disclosed herein.

The device 10 executing the application can provide a profile creation screen 21 in the user interface, and the profile creation screen 21 can comprise data fields 22 in which the user can enter identifying information and/or information regarding factors for the risk of obesity later in life of an infant or a young child. For example, the user can enter into the profile creation screen one or more of the name of the mother, the weight of the mother before pregnancy, the height of the mother before pregnancy, whether the mother is breastfeeding the infant or not, the name of the infant, the birth weight of the infant, the length of the infant at birth, the height of the infant at birth, or the gender of the infant. In an embodiment, the device 10 executing the application provides the profile creation screen 21 in response to selection of the “start” button 12 in the introductory screen 11.

The profile creation screen 21 can comprise one or more of a “growth curve” (or a “weight gain”) button 23, a “BMI” button 24, an “obesity information” button 25, a “guest mode” button 26, or a parameters button 27, all of which are discussed in more detail hereafter. The profile creation screen 21 can comprise a “create” button 28, and selection of the “create” button 28 can prompt the application to create a profile for the user such that the profile includes the information entered into the data fields 22.

The device 10 executing the application can provide a profile summary screen 31 in the user interface, and the profile summary screen 31 can comprise the information entered into the data fields 22 and/or stored as the profile. In an embodiment, the device 10 executing the application provides the profile creation screen 21 in response to selection of the “create” button 28. The profile summary screen 31 can comprise an “edit” button 32 that can prompt the application to provide the profile creation screen 21 or another screen with the data fields 22 in the user interface.

The device 10 executing the application can store at least a portion of the profile. Alternatively or additionally, a remotely located database can store at least a portion of the profile. In an embodiment, the remotely located database is connected to the device 10 by a wireless network, such as the internet.

The profile summary screen 31 can comprise an “evaluate” button 33, and selection of the “evaluate” button 33 can prompt the application to perform an analysis of the information entered into the data fields 22 and stored as the profile. The application may have criteria by which the information in the profile is analyzed and/or with which the information in the profile is compared. For example, the criteria can specify the presence or absence of factors for the risk of obesity later in life of an infant or a young child. As another example, the criteria can comprise one or more thresholds for comparison with the information entered into the data fields 22 and/or for comparison with values derived from the information entered into the data fields 22.

In a preferred embodiment, the criteria by which the application analyzes the information in the profile is periodically updated. For example, if a newly identified factor for the risk of obesity later in life of an infant or young child is identified, the application can be updated so that subsequent uses of the application determine whether the newly identified factor is present. The application can provide an additional data field 22 and/or can perform additional analysis as a result of the update. As another example, if criteria by which the application analyzes the information in the profile changes, the application can use the new criteria in analysis of the factors for the risk of obesity later in life of an infant or a young child.

As an example of determination of whether a factor for the risk of obesity later in life of an infant or young child is present or absent, the device 10 executing the application can determine the BMI of the mother before pregnancy and compare this value to a threshold, such as 25 kg/m² for example. If the BMI of the mother exceeds the corresponding threshold, the application can specify that a factor for risk of obesity later in life is present. If the BMI of the mother falls below the corresponding threshold, the application can specify that a factor for risk of obesity later in life is absent. As another example, the device 10 executing the application can compare the birth weight of the infant to a threshold, such as 4 kg for example. If the birth weight of the infant exceeds the corresponding threshold, the application can specify that a factor for risk of obesity later in life is present. If the birth weight of the infant falls below the corresponding threshold, the application can specify that a factor for risk of obesity later in life is absent. As yet another example, the device 10 executing the application can identify whether the mother is breastfeeding the infant, or not. If the mother is not breastfeeding the infant, the application can specify that a factor for risk of obesity later in life is present. If the mother is breastfeeding the infant, the application can specify that a factor for risk of obesity later in life is absent. As yet another example, the device 10 executing the application can detect whether the infant or a young child has a rapid weight gain. A rapid weight gain, also named a rapid weight-for-length gain, a rapid weight percentile increase or a rapid weight-for-length percentile increase, occurs for example when the growth curve (i.e. the weight-for-length evolution over time) of the infant crosses at least one (i.e. one or more such as 1, 2 . . . ) major percentile on the World Health Organization Growth Curve during the first two years of age.

Other information and criteria not known to be related to the risk of obesity at the time of this patent application but later discovered to be a factor can be used by the application executed by the device 10, and the present disclosure is not limited to the above examples of the information and the criteria. The information and the criteria can be any information and criteria found to be related to the risk of obesity later in life of an infant or young child, respectively.

The results of the analysis can be provided in the user interface of the device 10 executing the application. In an embodiment, the results of the analysis are provided in the user interface in an evaluation summary screen 41. The evaluation summary screen 41 can identify the factors for risk of obesity later in life that were analyzed and whether each factor is present or not.

The evaluation summary screen 41 may identify any factor for risk of obesity later in life that was not analyzed and/or may display a suggestion that such a factor be monitored and entered into the application. For example, the evaluation summary screen 41 may indicate that the weight gain of the infant or young child is considered a factor for risk of obesity later in life and suggest that the weight and length of the child be entered into the application periodically to monitor this factor. In such an embodiment, the evaluation summary screen 41 may indicate that a risk of obesity later in life is based on the percentile of the weight-for-length of the infant or young child relative to other infants or young children of the same age and gender, and this factor is present if the weight-for-length of the infant or young child increases by at least one major percentile.

The evaluation summary screen 41 can specify a preliminary conclusion regarding the risk of obesity later in life. In a preferred embodiment, the factors for risk of obesity later in life of an infant or young child comprise four factors, namely whether the mother was overweight or obese before pregnancy, the birth weight of the infant, whether the mother is breastfeeding the infant or young child or not, and a rapid weight gain of the infant or the young child. Other factors for risk of obesity not known at the time of this patent application but later discovered to be a factor can be evaluated by the application executed by the device 10, and the present disclosure is not limited to the above examples of factors for the risk of obesity later in life. The factors for risk of obesity later in life of an infant or a young child can be any factors related to the risk of obesity later in life of an infant or a young child.

The evaluation summary screen 41 can identify how many factors for the risk of obesity later in life were evaluated and how many factors were present or absent. For example, the preliminary conclusion can be zero factors out of four, one factor out of four, two factors out of four, or three factors out of four. Preferably the user is initiating use of the application at a time proximate to the birth of the infant, in which case the fourth factor, i.e. the weight percentile increase of the infant or young child, cannot be determined. However, after at least a portion of the growth curve is entered as discussed in more detail hereafter, the application can consider the weight-for-length percentile increase and determine whether the fourth factor is present or not.

As another example, the preliminary conclusion can comprise a value on a sliding scale. In such an embodiment, the application can assign a multiplier to each of the factors, determine which factors are present, and specify a value associated with the risk of obesity later in life. The multiplier can be based on how much the corresponding factor affects the risk of obesity later in life. For example, some previous studies (Horta BL et al., WHO Press 2007; Salsberry PJ et al., Pediatrics, 2005 December; 116(6):1329-38; Taveras EM et al., Arch Pediatr Adolesc Med. 2011; 165(11):993-8; Yu ZB et al., Obes Rev. 2011 July; 12(7):525-42) have suggested that a lack of breastfeeding increases the risk by 28%, the mother having a BMI equal to or exceeding 25 kg/m² before pregnancy increases the risk by 191%, a birth weight of the infant over 4 kg increases the risk by 107%, and rapid weight gain such that the weight of the infant or young child relative to infants or young children of the same age and gender increases by at least one major percentile increases the risk by 108%. The multipliers can be determined accordingly. In such an embodiment, the value associated with the risk of obesity later in life can be based on an amount by which information entered into the data fields 22 exceeds or falls below a threshold, for example the amount by which the BMI of the mother exceeds or falls below 25 kg/m² and/or the amount by which the birth weight of the infant exceeds or falls below 4 kg.

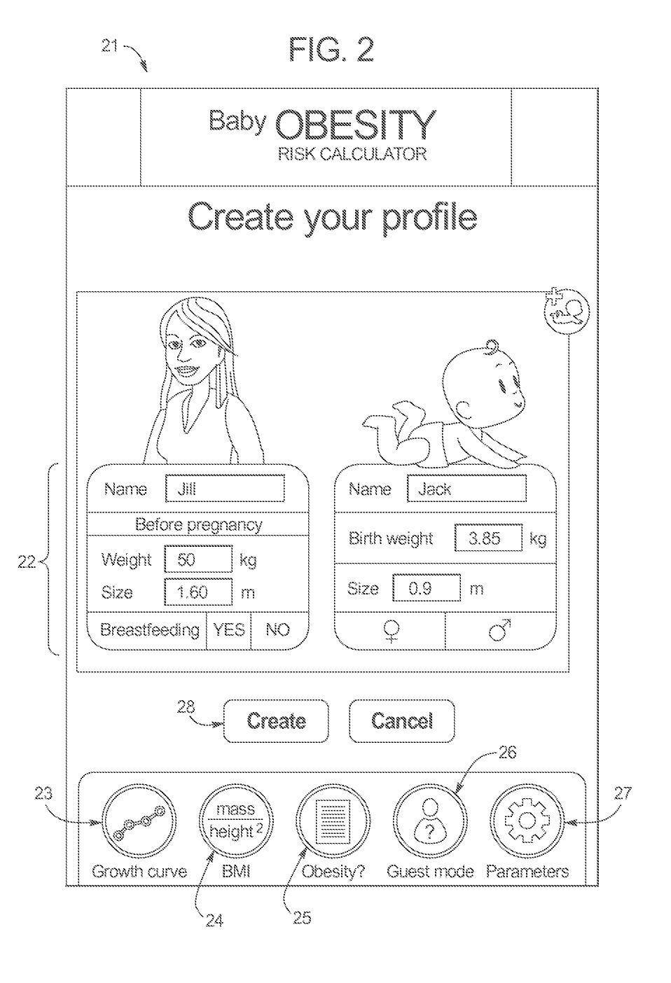

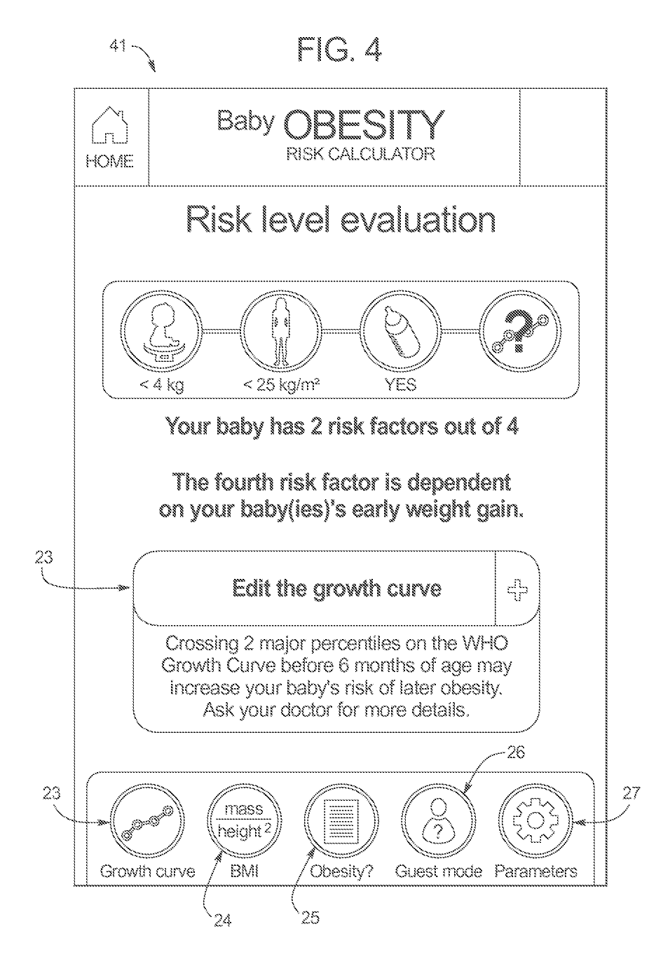

The device 10 executing the application can enable the user to sequentially and/or periodically input the weight and length of the infant or young child so that the weight gain is monitored and evaluated by the application. For example, as generally illustrated in FIGS. 1-4, the user interface provided by the device 10 executing the application can comprise the “growth curve” (or “weight gain”) button 23 on one or more of the profile creation screen 21, the profile summary screen 31, the evaluation summary screen 41, or another screen.

The device 10 executing the application can provide a growth curve screen (or weight gain screen) 51 of the user interface. In an embodiment, the device 10 executing the application provides the growth curve screen 51 in response to selection of the “growth curve” (or “weight gain”) button 23. The growth curve screen 51 can identify one or more weight-for-length value of the infant or young child and, for each one, the corresponding age of the infant or young child when the value was measured. Preferably the growth curve can be determined for at least the first six months after birth of the infant or young child. The application may automatically identify the birth weight and birth length entered into the data fields 22 as an initial data point. Preferably, the growth curve (or weight gain) is displayed in a graph 52 with the weight-for-length as the y-axis and the age as the x-axis.

The user can utilize the device 10 executing the application to sequentially enter a plurality of weights and lengths of the infant or young child, and the application may generate and/or update the growth curve, for example by interpolating and/or extrapolating the growth curve. The graph may additionally display one or more reference growth curves, and each reference growth curve can be associated with a percentile of infants or young children of the same age and gender. Preferably the growth curve (or weight gain) of the infant or young child and/or the reference growth curves are for at least the first six months after birth. The growth curve can be based at least partially on at least two weight-for-length values of the infant or young child after birth and the corresponding ages, preferably at least three weight-for-length values of the infant or young child after birth and the corresponding ages, more preferably at least four weight-for-length values of the infant or young child after birth and the corresponding ages, and most preferably at least five weight-for-length values of the infant or young child after birth and the corresponding ages. The intervals between the different weights and lengths measures of the infant or young child after birth can be fixed (for example the weights and lengths are determined every week, every two weeks, every month or every two months . . . ) or randomly (for example a first measure is made after 1 week of birth, then a second one after 1 month of birth then a third one after 3 months of birth, then a fourth one after 6 months of birth . . . ).

The user can enter the plurality of weights and lengths measures using any known input component of the device 10 executing the application, such as a keyboard, a touchscreen, a trackball, and the like, and the present disclosure is not limited to a specific embodiment of the input component of the device 10. For example, if the device 10 has a touchscreen, the user can touch a section of the graph to input a weight in association with an age.

If the user enters a new data point for the growth curve, the device 10 executing the application can perform an analysis of the growth curve to determine whether a risk of obesity later in life is present. The device 10 can perform the analysis in response to user input requesting the analysis or can automatically perform the analysis in response to entry of the new data point. Preferably the analysis comprises, for each data point, a determination of which percentile of infants or young children of the same age and gender encompasses the weight-for-length and further comprises comparison of the percentiles of the different ages of the infant or young child to each other. For example, the analysis can determine that this factor is present if the weight gain of the infant or young child increases by at least one major percentile.

In an embodiment, results of the analysis of the growth curve are provided on the evaluation summary screen 41. For example, the evaluation summary screen 41 can be provided in the user interface of the device 10 after the growth curve screen 51, and the evaluation summary screen 41 can specify an updated conclusion regarding the risk of obesity later in life. The evaluation summary screen can indicate that the BMI of the mother before pregnancy, the birth weight of the infant, whether the mother is breastfeeding the infant or not, and the weight gain of the infant or young child were evaluated. For example, the updated conclusion can be zero factors out of four, one factor out of four, two factors out of four, three factors out of four, or four factors out of four. As another example, the updated conclusion can comprise a value on a sliding scale. The conclusion on the evaluation summary screen 41 can be updated automatically each time a new data point is entered for the growth curve and/or can be updated when requested by input into the user interface of the device 10 by the user.

If the weight gain (or growth curve) shows that the weight-for-length of the infant or young child is close to increasing by at least one major percentile, the application can provide a warning in the user interface of the device 10 executing the application. The warning can be text and/or graphics. In an embodiment, the warning can comprise a message that may be an educational information; an alert on the risk for the infant or the young child to become obese, or a recommendation suggesting a visit to a healthcare professional who may provide a nutritional suggestion, i.e. a recommendation of a nutritional composition or a set of nutritional compositions for the infant or the young child.

Additional information or functionality can be provided by the evaluation summary screen 41 and/or another screen of the user interface of the device 10 executing the application. For example, the additional information or functionality can comprise an indication that that the profile and the results of the analysis thereof are stored by the application, a recommendation that the profile and the results of the analysis thereof should be shared with a pediatrician, a recommendation that the parent take the infant or young child to a pediatrician, an interactive quiz or game highlighting the potential burden of obesity for the infant or young child, a button for sharing the application with friends and family, an explanation of one or more of the buttons provided in the user interface, a “close” button to end the current session of the application.

The device 10 executing the application can provide a BMI explanation screen 61 of the user interface. In an embodiment, the device 10 executing the application provides the BMI explanation screen 61 in response to selection of the “BMI” button 24. The BMI explanation screen 61 can identify the information in the profile related to the weight and the height of the mother before pregnancy, the resultant BMI, and well established BMI ranges. For example, the BMI explanation screen 61 can indicate that a BMI less than 16.5 is classified as “severely underweight”, a BMI from 16.5 to 18.5 is classified as “underweight”, a BMI from 18.5 to 25 is classified as “normal”, a BMI from 25 to 30 is classified as “overweight”, a BMI from 30 to 35 is “moderately obese”, a BMI from 35 to 40 is “severely obese” and a BMI over 40 is classified as “very severely obese.”

The device 10 executing the application can provide an obesity information screen 71 of the user interface. In an embodiment, the device 10 executing the application provides the obesity information screen 71 in response to selection of the “obesity information” button 25. The obesity information screen 71 can provide information regarding obesity and/or can provide buttons which can be selected to obtain information regarding obesity. The information can be presented as text and/or graphics, such as animation, in the user interface of the device 10 executing the application.

For example, the obesity information screen 71 can identify the factors in the risk of obesity later in life of an infant or young child, such as the BMI of the mother before pregnancy, the weight of the infant at birth, whether the infant or young child receives breast-feeding or not, and a rapid weight gain of the infant or young child. The obesity information screen 71 can suggest that a pediatrician be consulted for an infant having a mother with a BMI above 25 before pregnancy, having a weight at birth more than 4 kg, not being breastfed, or having a weight gain crossing at least one major percentile during the first two years of age.

As another example, the obesity information screen 71 can identify diseases caused or made worse by obesity in childhood and adulthood, such as stroke, sleep problems, heart disease and high blood pressure, joint problems, depression and low self esteem, breathing difficulties and/or asthma, diabetes, liver disease, and circulation problems. The obesity information screen 71 can indicate that nearly eight out of ten obese children grow up to be obese adults.

As yet another example, the obesity information screen 71 can indicate that obesity is not solely determined by genes but is determined by other factors, such as nutrition. The obesity information screen 71 can indicate that too much of certain nutrients in early life can program a tendency to gain weight later in life, known as early metabolic programming. The obesity information screen 71 can suggest that a mother unable to breastfed her infant should consult a doctor.

The device 10 executing the application can provide a guest mode screen 81 of the user interface. In an embodiment, the device 10 executing the application provides the guest mode screen 81 in response to selection of the “guest mode” button 26. The guest mode screen 81 can enable the user to utilize the application in a one-time use without creating a profile. The guest mode screen 81 can provide the data fields 22 so that the application can perform an analysis of the risk of obesity later in life of an infant or young child during the one-time use.

The device 10 executing the application can provide a parameters screen 91 of the user interface. In an embodiment, the device 10 executing the application provides the parameters screen 91 in response to selection of the parameters button 27. The parameters screen 91 can enable the user to establish and/or change settings of the application, such as the language and the units of measurement, and can enable the user to view information about the application, such as a legal notice and information about the provider of the application.

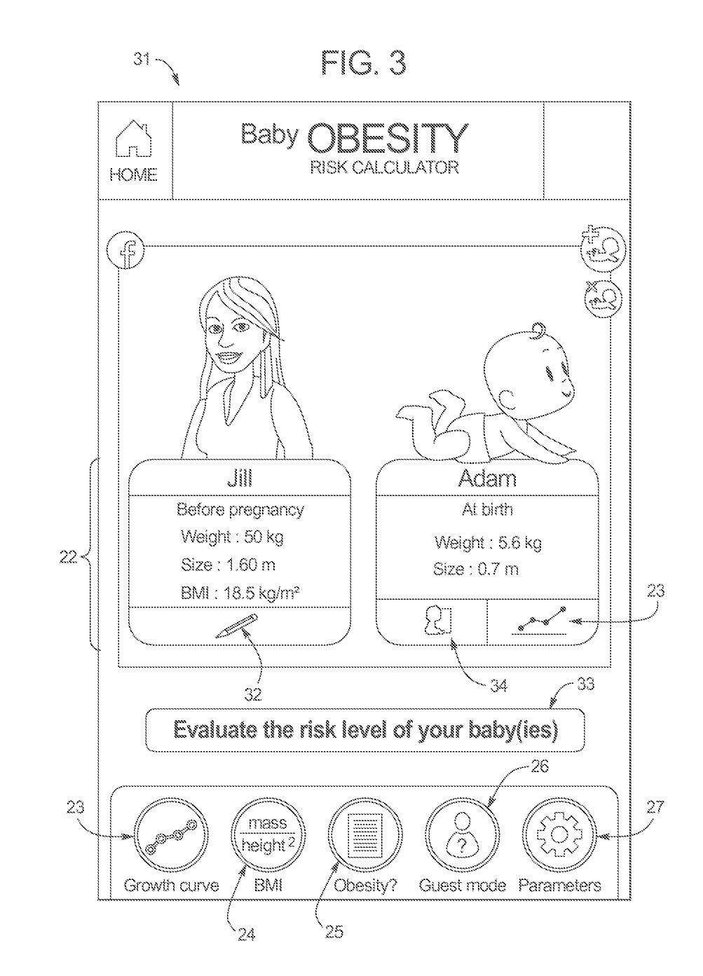

The device 10 executing the application can enable the user to access the information in the profile, for example for sharing the information in the profile with a pediatrician. In an embodiment, the information in the profile can be accessed by selecting a “review” button 34 that can be provided in any screen in the user interface of the device 10 executing the application. For example, as shown in FIG. 3, the profile summary screen 31 can provide the “review” button 34.

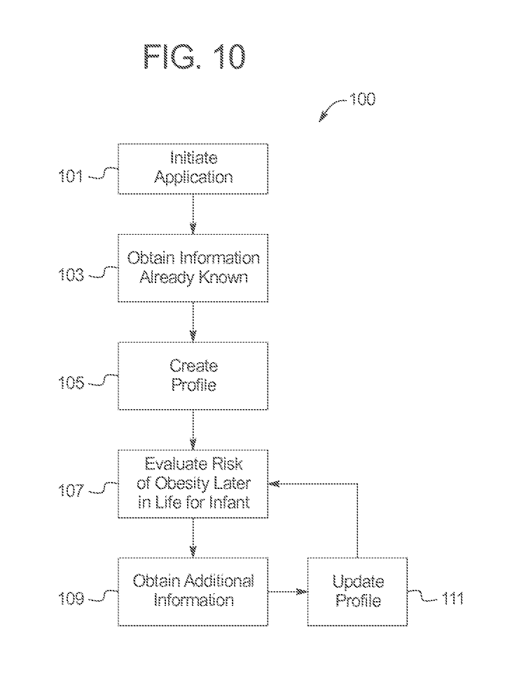

FIG. 10 generally illustrates a flowchart of an embodiment of a method 100 provided by the present disclosure. The method 100 can be implemented on a device comprising a processor, for example a mobile telephone, such as a smartphone; a laptop computer; a desktop personal computer; a tablet; or a personal digital assistant.

In Step 101, the application can be initiated, and initiation of the application can comprise purchasing the application from an application store, downloading the application onto the device comprising the processor, accessing the application over the internet using a web browser of the device, or the like. A remotely located database can transmit the application to the device and/or host a website accessible to the device. In an embodiment, initiation of the application comprises selecting an icon associated with the application in a user interface of the device.

In Step 103, the application can obtain information related to the risk of obesity later in life of an infant or young child. Preferably the user of the device manually enters the information into the application using the device. In an embodiment, the application provides data fields in the user interface of the device requesting the information. The information can be, for example, the weight of the mother before pregnancy, the height of the mother before pregnancy, whether the mother is breastfeeding the infant or not, the birth weight of the infant, the height of the infant at birth, or the gender of the infant. Other information not known to be related to the risk of obesity at the time of this application but later discovered to be a factor can be requested and/or entered in step 103, and the present disclosure is not limited to these examples of the information.

In Step 105, the application can create a profile for the user, and the profile can comprise the information related to the risk of obesity later in life of the infant or young child. The device executing the application can store at least a portion of the profile. Alternatively or additionally, a remotely located database can store at least a portion of the profile. In an embodiment, the remotely located database is connected to the device 10 by a wireless network, such as the internet. The application can create a profile automatically or in response to user input on the device executing the application. Step 105 can be omitted in an embodiment, and the application can be executed without creating a profile for the user and/or without storing the information entered by the user.

In Step 107, the application can perform an analysis of the information in the profile to evaluate the risk of obesity later in life for the infant or young child. For example, the analysis can be based at least partially on comparison of the BMI of the mother before pregnancy to a threshold, such as 25 kg/m² for example; comparison of the birth weight of the infant to a threshold, such as 4 kg for example; and determination if the mother is breastfeeding the infant or young child or not. The user interface of the device executing the application can provide results of the evaluation of the information in the profile, such as which factors for risk of obesity later in life of an infant or young child are present, which factors for risk of obesity later in life of an infant or young child are absent, a numeric value, and/or the like.

In Step 109, the application can obtain additional information subsequent to when the information is obtained in step 103. For example, the additional information can comprise a weight value and a length value of the infant or young child at a specific age of the infant or young child, and the weight value and the length value of the infant or young child at the specific age can be obtained by the application proximate to when the infant or young child reached the specific age. Preferably the user of the device manually enters the additional information into the application using the device.

In Step 111, the application can update the profile to include the additional information. In an embodiment, the application generates or adjusts a growth curve of the infant or young child based on the additional information. Then the updated profile and the information in the profile can be used to evaluate the risk of obesity later in life for the infant or young child again, in step 107. The application can update the profile in Step 111 and evaluate the risk of obesity later in life for the infant or young child in Step 107 each time additional information, such as new weight and length values of the infant or young child, is entered in Step 107. Step 111 can be omitted in an embodiment in which the application is executed without creating a profile for the user and/or without storing the information entered by the user.

As set forth above, the application executed by the device 10 can provide a message or a warning based at least partially on the information related to the risk of obesity later in life of the infant or the young child. The message may be either an educational information; an alert on the risk for the infant or the young child to become obese, or a recommendation suggesting a visit to a health care professional who may provide a nutritional suggestion, that is to say a recommendation of a nutritional composition or of a set of nutritional compositions for the infant or the young child. With the application executed by the device 10, the parents of the infant/young child can be alerted to a risk for their infant or young child to become obese and for example they may be advised to consult a health care professional for advice on possible nutritional solutions. For example, the application can provide the message or warning after evaluation of the information input by the user; when a portion of the information meets a predetermined value or characteristic, such as when a specific age or weight of the infant or young child is reached; or any other time during execution of the application by the device 10. As a specific non-limiting example, the application can provide a message or warning when the increase in the growth curve exceeds or almost exceeds at least one major percentile.

The nutritional suggestion from the health care professional can comprise identification of a composition or a set of nutritional compositions (e.g. an age-tailored system) for administration to the infant or young child, such as a type of starter infant formula, follow-up or follow-on infant formula, growing up milk, supplements, or the like. In an embodiment, instructions for obtaining and/or using the application can be included with a nutritional composition, for example on the packaging of the nutritional composition. In an embodiment, instructions for obtaining and/or using the application can be sent to a consumer that purchased the nutritional composition, for example by email, text message, SMS, voicemail, hard copy mail, or any means known to one skilled in the art. As a specific non-limiting example, the nutritional suggestion from the health care professional can be a nutritional composition such as an infant formula which provides a hormonal profile closer to that of breast fed infants when the infant is not breast fed. As another specific non-limiting example, it can be a nutritional composition which provides a specific certain protein content and/or a specific energy content and/or a specific lipid content. The health care professional can also suggest adapting the ingested quantity of a nutritional composition.

In an embodiment, the health care professional can recommend as nutritional suggestion the infant formula disclosed in U.S. patent application Ser. No. 12/519,043 published as U.S. 2010/0092610 on Apr. 15, 2010, herein incorporated by reference in its entirety. For example, the nutritional suggestion can be feeding the infant a nutritional composition comprising a protein source, a lipid source and a carbohydrate source and having a protein content of less than 1.8 g/100 kcal and an energy density of less than 650 kcal/liter. The nutritional composition can have a characteristic that is one or more of a protein content between 1.4 and 1.7 g/100 kcal; a casein:whey ratio from 70:30 to 30:70, such as 40:60; free amino acids such that the composition comprises the minimum requirements for essential amino acid content; a carbohydrate content between 9 and 14 g/100 kcal; a lipid content between 4.4 and 6 g/100 kcal; a ratio of linoleic acid (C18:2n-6): α-linolenic acid (C18:3n-3) less than 7:1, such as between 7:1 and 5:1; a ratio of arachidonic acid (C20:4n-6):docosahexaenoic acid (C22:6n-3) between 2:1 and 1.1; all vitamins and minerals understood to be essential in the daily diet in nutritionally significant amounts; probiotic bacteria; dietary fibers; lactoferrin; nucleotides; or nucleosides. In an embodiment, the health care professional can recommend that this composition is fed to an infant as the sole source of nutrition from the age of three months and subsequently as part of a mixed diet during the introduction of solid foods until weaning is complete at about the age of 12 months.

The health care professional can recommend an age-tailored nutritional composition system. The age-tailored nutritional composition system can comprise a mix of different kinds of compositions, for example selected from the list consisting of starter infant formula, follow-up or follow-on infant formula, growing up milks, supplements, or the like. The age-tailored nutritional composition system can also comprise different compositions belonging to the same types, for example it may be an age-tailored infant formula system, which is a system comprising several infant formula. For example, a first infant formula is fed to the infant in a first stage, such as from birth to at least two months and preferably to three months, and a second infant formula is fed to the infant thereafter until, for example, nine, twelve or eighteen months.

The first infant formula can have a protein content of at least 1.8 g/100 kcal, preferably from 1.8 to 2.5 g/100 kcal, such as from 1.8 to 2.0 g/100 kcal or from 1.9 to 2.0 g/100 kcal. In a particular embodiment, the amount of protein of the first infant formula is higher than 2.0 g/100 kcal, such as from 2.05 to 2.5 g/100 kcal. The second infant formula can have a protein content below 1.7 g/100 kcal. In an embodiment, the protein content in the second infant formula is below 1.69 g/100 kcal, such as below 1.68 g/100 kcal, preferably below 1.67 g/100 kcal, even more preferably below 1.66 g/100 kcal. In another embodiment, the second infant formula comprises protein in an amount from 1.4 to 1.69 g/100 kcal, such as from 1.4 to 1.68 g/100 kcal, such as from 1.5 to 1.67 g/100 kcal, such as from 1.5 to 1.66 g/100 kcal, preferably from 1.55 to 1.65 g/100 kcal. Both infant formulas also supply sufficient quantities of other nutrients which are essential for growth and development.

The age-tailored infant formula system suggested by the health care professional can comprise additional infant formulas with lower amounts of protein present than the second infant formula. For example, the second infant formula may comprise 1.67 g protein/100 kcal, while a third infant formula comprises 1.62 g protein/100 kcal and a fourth infant formula comprises 1.57 g protein/100 kcal.

Another example of an age-tailored nutritional composition system can be made by a succession of at least three nutritional compositions, for example at least 2 infant formulas and one growing-up milk. There may be a succession of one, two, three or more infant formulas followed by a succession of one, two, three or more growing-up milks. The protein amount may vary over the ages, and especially decrease over the ages, as well as the whey:casein ratio. In an embodiment, the age-tailored nutritional composition system may comprise:

first nutritional composition (e.g. infant formula) with protein in an amount of 1.75-3.0 g/100 kcal, that may be administered to the infant from birth and until 3-6 months of life of said infant,

a second nutritional composition (e.g. infant formula) with protein in an amount of 1.5-1.75 g/100 kcal, that may be administered to the infant from 3-6 months and until 1 year of life of said infant,

a third nutritional composition (e.g. growing-up milk) with protein in an amount comprised between 1.3 and 1.5 g/100 kcal, that may be administered to the young child after 12 months, such as from 1 to 2 years or from 1 to 3 years.

In another embodiment the age-tailored nutritional composition system may comprise:

a first nutritional composition (e.g. infant formula) with protein in an amount of 2.4-3.0 g/100 kcal, that may be administered to the infant from birth and until the first 3 to 15 days,

a second nutritional composition (e.g. infant formula) with protein in an amount of 1.75-2.4 g/100 kcal, that may be administered from the first 3 to 15 days and until 3 months of life of the infant,
a third nutritional composition (e.g. infant formula) with protein in an amount of 1.5-1.75 g/100 kcal, that may be administered to the infant from 3 months and until 1 year of life of said infant,

a fourth nutritional composition (e.g. growing-up milk) with protein in an amount comprised between 1.3 and 1.5 g/100 kcal, that may be administered to the young child after 12 months, such as from 1 to 2 years or from 1 to 3 years.

In another embodiment of the present invention, the age-tailored nutritional composition system may comprise:

a first nutritional composition (e.g. infant formula) with protein in an amount of 2.4-3.0 g/100 kcal, that may be administered to the infant from birth and until the first 3 to 15 days,

a second nutritional composition (e.g. infant formula) with protein in an amount of 1.9-2.4 g/100 kcal, that may be administered from the first 3 to 15 days and until 1 month of life of the infant,

a third nutritional composition (e.g. infant formula) with protein in an amount of 1.75-1.9 g/100 kcal, that may be administered from 1 month and until 3 months of life of the infant,

a fourth nutritional composition (e.g. infant formula) with protein in an amount of 1.5-1.75 g/100 kcal, that may be administered to the infant from 3 months and until 1 year of life of said infant,

a nutritional composition (e.g. growing-up milk) with protein in an amount comprised between 1.3 and 1.5 g/100 kcal, that may be administered to the young child after 12 months, such as from 1 to 2 years or from 1 to 3 years.

These examples are for illustrative purposes only.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
accepting user input into an application executed by a device comprising a processor, the user input comprising weights and lengths of an infant or young child at a plurality of ages after birth; and
performing an analysis of the risk of obesity later in life for the infant or young child based at least partially on the weights and lengths of the infant or young child, and the analysis is performed by the application executed by the device.

2. The method of claim 1 comprising providing a message or a warning on the device based at least partially on the analysis, and the message or the warning is selected from the group consisting of an alert for the infant or young child to become obese, a recommendation suggesting a visit to a healthcare professional, educational information regarding the risk of obesity later in life of the infant or young child, and combinations thereof.

3. The method of claim 1 wherein the analysis is at least partially based on whether the infant is breastfed.

4. The method of claim 1 wherein the analysis is at least partially based on a criterion selected from the group consisting of a threshold pre-pregnancy body mass index (BMI) of the mother of the infant or young child, a threshold weight of the infant at birth, and combinations thereof.

5. The method of claim 1 comprising generating a weight gain or growth curve based at least partially on the weights and lengths at the plurality of ages.

6. The method of claim 1 comprising updating the application based on a criterion for the risk of obesity later in life that was identified after the device obtained the application.

7. A device comprising a processor that executes an application that directs the device to provide data fields for entry of information related to a risk of obesity later in life of an infant or young child, the information comprising weights and lengths of the infant or young child at a plurality of ages after birth, and the application uses the processor to evaluate the risk of obesity later in life of the infant or young child based at least partially on the information.

8. The device of claim 7 wherein the device is selected from the group consisting of a tablet, a smartphone, a desktop computer, a laptop computer, and a personal digital assistant.

9. The device of claim 7 wherein the device accepts the weights and lengths of the infant or young child sequentially.

10. A system comprising a database connected to a remotely located device comprising a processor executing an application that evaluates a risk of obesity later in life of an infant or young child, and the database updates the application on the device with a factor for the risk of obesity later in life of an infant or young child.

11. The system of claim 10 wherein the database stores at least a portion of information entered into the application on the device relating to the risk of obesity later in life of a specific infant or young child.

12. A method comprising:
accepting user input into an application executed by a device comprising a processor, the user input comprising information related to a first factor associated with a risk of obesity later in life of an infant or young child, the user input accepted at a first time;
accepting additional user input into the application at a second time subsequent to the first time, the additional user input comprising information related to a second factor associated with the risk of obesity later in life for the infant or young child; and
performing an analysis of the risk of obesity later in life of the infant or young child, the analysis based at least partially on the information related to the first and second factors.

13. The method of claim 12 wherein the first factor is selected from the group consisting of whether the infant is breastfed, a pre-pregnancy body mass index (BMI) of the mother of the infant or young child, a weight of the infant at birth, and combinations thereof.

14. The method of claim 12 wherein the second factor comprises weight-for length values or both the weights and the lengths of the infant or young child at a plurality of ages after birth as percentiles relative to other infants or young children of the same age and gender.

15. A method comprising:
accepting user input into an application executed by a device comprising a processor, the user input comprising information related to a risk of obesity later in life of an infant or young child; and
providing a message or a warning at least partially on the information related to the risk of obesity later in life of the infant or young child, and that is provided by the application in a user interface of the device.
